(19) United States
(12) Patent Application Publication
(10) Pub. No.: US 2013/0314327 A1
(43) Pub. Date: Nov. 28, 2013

(54) FRAMELESS TOUCH PANEL

(71) Applicant: YU-CHOU YEH, TAOYUAN COUNTY (TW)

(72) Inventor: YU-CHOU YEH, TAOYUAN COUNTY (TW)

(73) Assignee: J TOUCH CORPORATION, TAOYUAN COUNTY (TW)

(21) Appl. No.: 13/477,166

(22) Filed: May 22, 2012

(51) Int. Cl. G06F 3/041

(52) U.S. Cl. 345/173

(57) ABSTRACT

This invention discloses a touch panel used in an electronic device having a contour line, and the touch panel includes a covered area disposed on a surface of the electronic device and a transparent touch area disposed adjacent to the covered area, and most of the transparent touch area are surrounded by the contour line of the electronic device.

### BACKGROUND OF THE INVENTION

1. Field of the Invention

The present invention relates to a touch panel, in particular to a frameless touch panel applied in a portable electronic device.

2. Description of the Related Art

As science and technology advance, general consumer electronic products such as mobile communication devices, digital cameras, digital music players (MP3), personal digital assistants (PDA), and global positioning systems (GPS) mainly use a touch panel as an operating interface, so that users can input instructions or perform operations to interact with the electronic products, so as to improve the user-friendliness of the man-machine communication interface and the input operating efficiency.

In general, the touch device available in the market usually comes with a screen, not only displaying vivid and lively images or pictures, but also allowing users to perform a touch operation on the screen. In order to cover or hide metal circuits inside the screen, the periphery of the touch panel is generally coated with a frame or an icon to maintain the aesthetic appearance. However, consumers have increasingly stricter requirements on the aesthetic appearance of an electronic product and prefer to have a touch screen with a larger display area, so that the concept of a frameless touch device began to emerge.

To implement the frameless touch device, it is necessary to hide the opaque metal circuit, but the prior arts still have difficulties and bottlenecks.

### SUMMARY OF THE INVENTION

In view of the aforementioned drawbacks, it is a primary objective of the present invention to provide a frameless touch panel capable of effectively increasing the display area, while concurrently taking the aesthetic effect into consideration.

To achieve the foregoing objective, the present invention provides a touch panel applied in an electronic device with a contour line, comprising: a covered area, situated on a surface of the electronic device; and a transparent touch area, situated adjacent to the covered area, and most of the transparent touch area are surrounded by the contour line of the electronic device.

In a preferred embodiment, the present invention provides a touch panel comprising: a protective substrate, having a covered area and a transparent touch area; a first sensing electrode layer, having a plurality of first sensing electrodes and a plurality of first lead wires, wherein the first sensing electrodes are installed under the transparent touch area of the protective substrate, and ends of the first lead wires are coupled to the first sensing electrodes respectively, and the first lead wires are installed under the covered area of the protective substrate; and a second sensing electrode layer, disposed under the first sensing electrode layer, and having a plurality of second sensing electrodes and a plurality of second lead wires, wherein the second sensing electrodes are installed on a surface of the second sensing electrode layer and under the transparent touch area of the protective substrate, and the second lead wires are installed on the other surface of the second sensing electrode layer, and ends of the second lead wires are coupled to the second sensing electrodes respectively.

### BRIEF DESCRIPTION OF THE DRAWINGS

FIG. 1A is a perspective view of a preferred embodiment of the present invention;

FIG. 1B is a schematic view of operating a frameless touch panel in accordance with a preferred embodiment of the present invention;

FIG. 2 is a schematic view of a preferred embodiment of the present invention;

FIG. 3 is a first cross-sectional view of connecting a second sensing electrode to a second lead wire in accordance with a preferred embodiment of the present invention;

FIG. 4 is a second cross-sectional view of connecting a second sensing electrode to a second lead wire in accordance with a preferred embodiment of the present invention; and

FIG. 5 is a third cross-sectional view of connecting a second sensing electrode to a second lead wire in accordance with a preferred embodiment of the present invention.

### DETAILED DESCRIPTION OF THE PREFERRED EMBODIMENTS

The technical contents of the present invention will become apparent with the detailed description of preferred embodiments and the illustration of related drawings as follows.

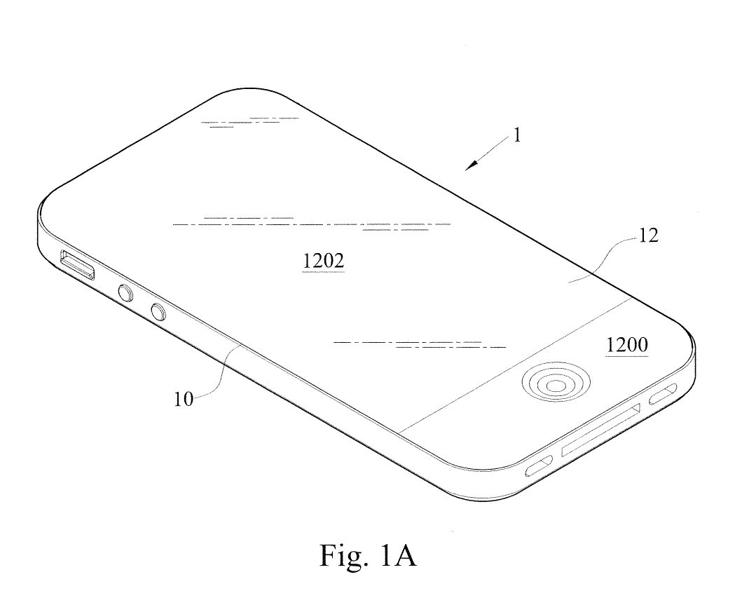

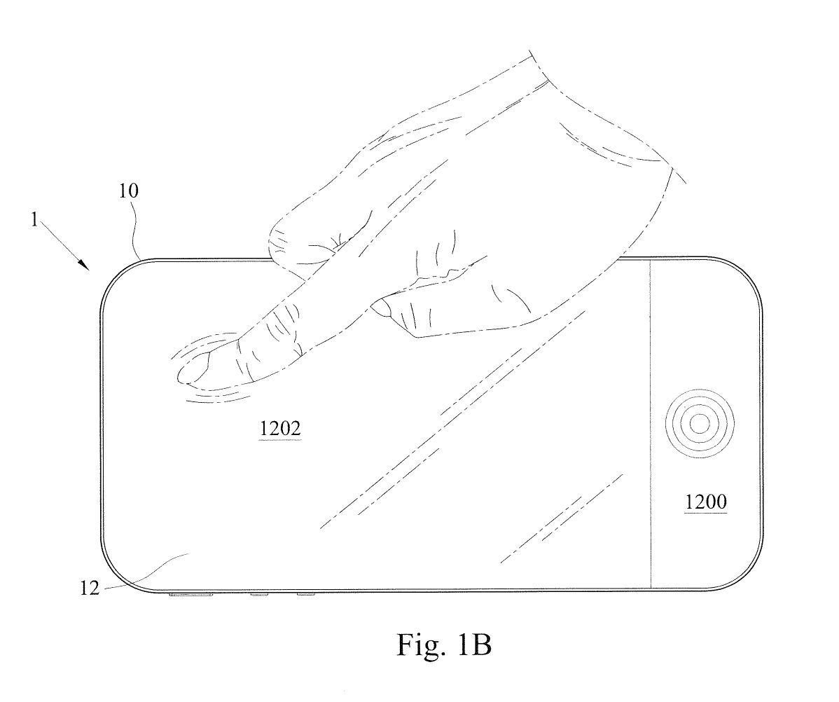

With reference to FIGS. 1A and 1B for a perspective view of a frameless touch panel and a schematic view of operating a frameless touch panel in accordance with a preferred embodiment of the present invention respectively, a touch panel 12 is applied in an electronic device 1, wherein the electronic device 1 can be a portable electronic device such as a smartphone or a flat PC having a contour line 10. The touch panel 12 includes a covered area 1200 and a transparent touch area 1202, and the covered area 1200 is disposed on a surface of the electronic device I, and the transparent touch area 1202 is disposed adjacent to the covered area 1200, and most of the transparent touch area 1202 are surrounded by the contour line 10 of the electronic device 1. In FIG. 1B, a user can perform a touch operation at any position of the transparent touch area 1202 other than the covered area 1200, and such position can even be very close to the contour line 10 of the electronic device 1, so that the electronic device 1 can obtain the maximum viewing area and operating area.

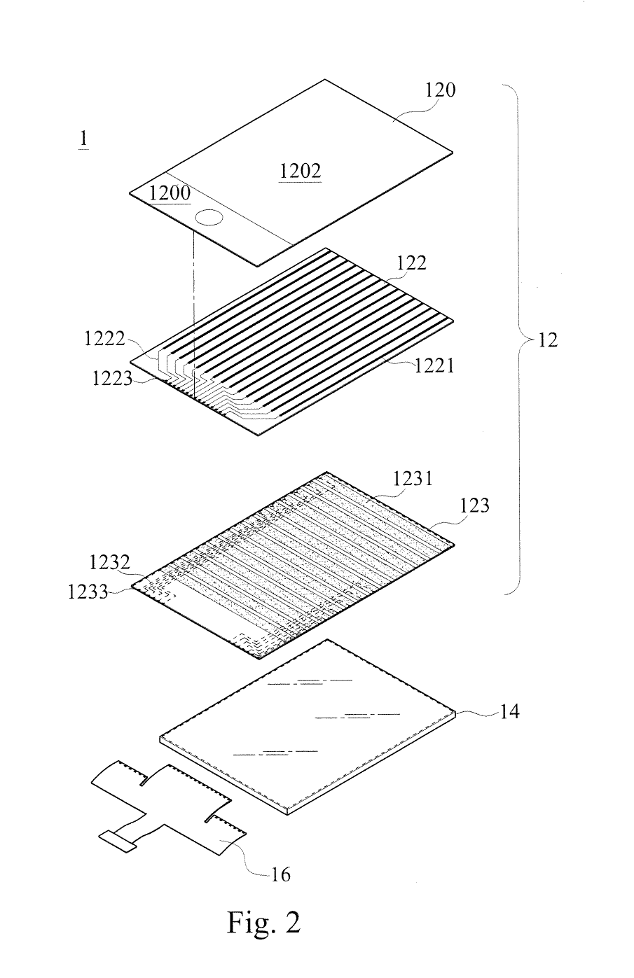

With reference to FIG. 2 for a schematic view of a frameless touch panel applied in an electronic device in accordance with a preferred embodiment of the present invention, the electronic device 1 comprises a touch panel 12, a flat panel display 14 and a flexible printed circuit board 16. The touch panel 12 comprises a protective substrate 120, a first sensing electrode layer 122 and a second sensing electrode layer 123. The protective substrate 120 includes a covered area 1200 and a transparent touch area 1202. In this preferred embodiment, the protective substrate 120 is a transparent thin plate made of glass, polycarbonate (PC), polyethylene terephthalate (PET), polymethyl methacrylate(PMMA) or cyclic olefin copolymer (COC). The covered area 1200 is made of an opaque material such as an ink, a color photoresist, an organic material or an inorganic material.

The first sensing electrode layer 122 includes a plurality of first sensing electrodes 1221 and a plurality of first lead wires 1222, wherein the first sensing electrodes 1221 are installed under the transparent touch area 1202 of the protective substrate 120, and ends of the first lead wires 1222 are coupled to the first sensing electrodes 1221 respectively, and the first lead wires 1222 are installed under the covered area 1200 of the protective substrate 120. In addition, the other end of each first lead wire 1222 is extended to a first electric connecting portion 1223, and the first electric connecting portions 1223 are situated at the middle of a lateral edge of the first sensing electrode layer 122 and provided for electrically coupling the flexible printed circuit board 16. It is noteworthy that the first sensing electrode 1221 of the present invention is preferably made of indium tin oxide (ITO), and the first lead wire 1222 is preferably a silver wire with a small impedance which is suitable to be used for transmitting signals.

The second sensing electrode layer 123 is situated under the first sensing electrode layer 122 and has a plurality of second sensing electrodes 1231 and a plurality of second lead wires 1232, wherein the second sensing electrodes 1231 are installed on a surface of the second sensing electrode layer 123 and under the transparent touch area 1202 of the protective substrate 120, and the second lead wires 1232 are installed on the other surface of the second sensing electrode layer 123, and ends of the second lead wires 1232 are coupled to the second sensing electrodes 1231 respectively. In addition, the other end of each second lead wire 1232 is extended to a second electric connecting portion 1233, and the second electric connecting portions 1233 are disposed on both sides of a lateral edge of the second sensing electrode layer 123 respectively, so that the first electric connecting portions 1223 and the second electric connecting portions 1233 are electrically insulated from each other, and the second electric connecting portions 1233 are electrically coupled to the flexible printed circuit board 16. It is noteworthy that the second sensing electrode 1231 of the present invention is preferably made of indium tin oxide (ITO). The second lead wire 1232 is preferably made of a transparent conductive material such as graphene, indium tin oxide, indium zinc oxide or zinc aluminum oxide, so that the second lead wire 1232 will not be visually observed. Further, a metal conductive wire with a very small width can also be used as the second lead wire 1232 to achieve the effect of being not visually recognized by naked eyes. It is noteworthy to point out that the flat panel display 14 of the electronic device 1 is installed under the transparent touch area 1202, so that images of the flat panel display 14 can be passed sequentially through the second sensing electrode layer 123, the first sensing electrode layer 122 and the transparent touch area 1202 to the user's eyes.

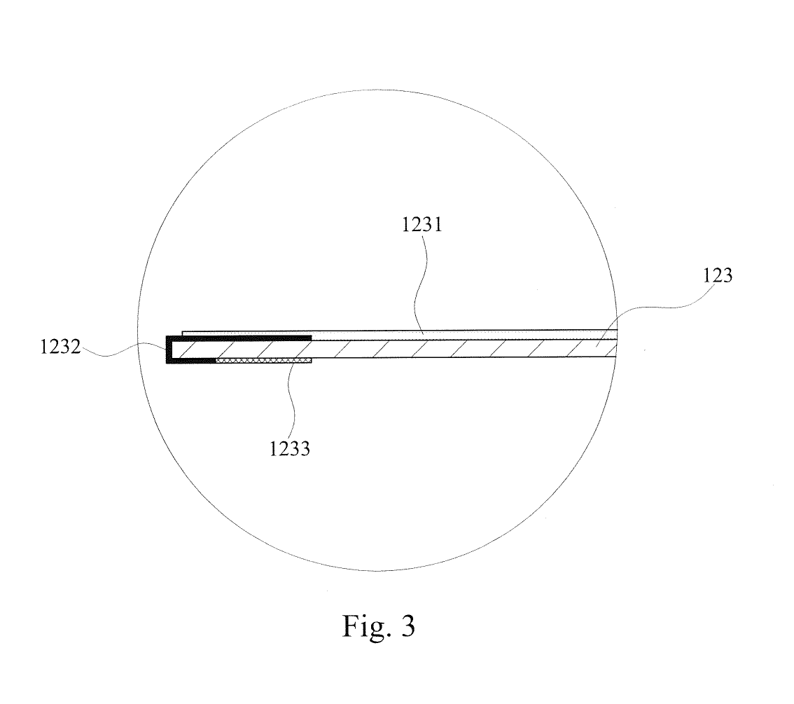

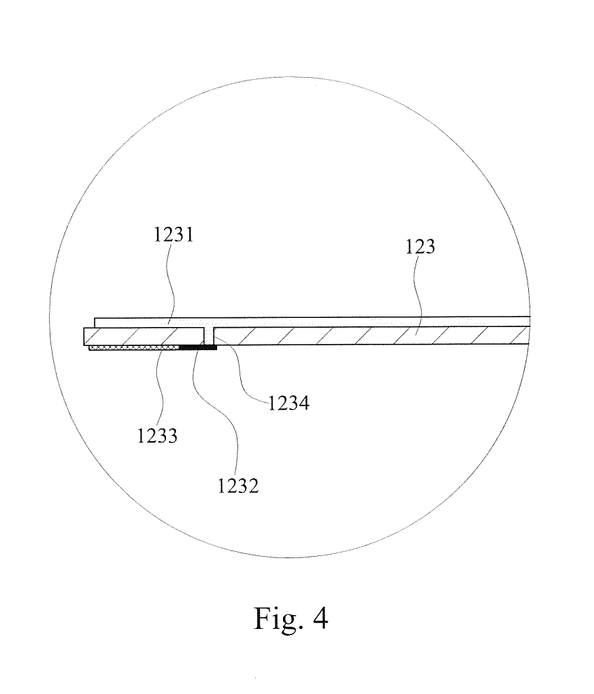

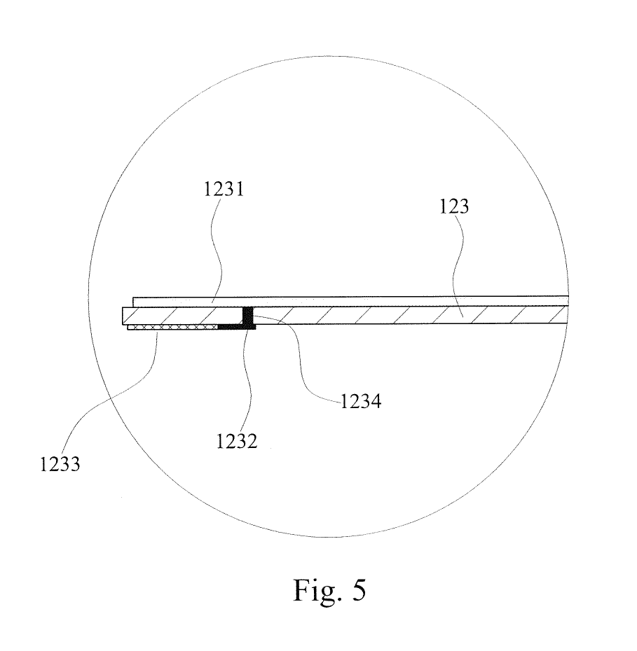

With reference to FIGS. 3 to 5 for cross-sectional views of different ways of connecting a second sensing electrode with a second lead wire in accordance with a preferred embodiment of the present invention respectively, FIG. 3 shows that the second sensing electrode layer 123 of the present invention comes with a special design, wherein each second lead wire 1232 is extended along a lateral edge of the second sensing electrode layer 123 and coupled to the corresponding second sensing electrode 1231, so that each second sensing electrode 1231 at the top of the second sensing electrode layer 123 and each second electric connecting portion 1233 at the bottom of the second sensing electrode layer 123 form an electric connection. In FIG. 4, the second sensing electrode layer 123 has a plurality of through holes 1234, and each second sensing electrode 1231 is passed through the through hole 1234 and coupled to the corresponding second lead wire 1232, and then electrically conducted with the second electric connecting portion 1233. The embodiment as shown in FIG. 5 is slightly different from the embodiment as shown in FIG. 4, and the difference resides on that each second lead wire 1232 is passed through the through hole 1234 and coupled to the corresponding second sensing electrode 1231.

In the present invention, the second lead wire 1232 is installed at the bottom of the second sensing electrode layer 123, not only increasing the touch area and display area of the touch panel 12, but also achieving the effect of having an aesthetic appearance of the frameless touch panel.

What is claimed is:

1. A touch panel, applied in an electronic device with a contour line, comprising:
a covered area, situated on a surface of the electronic device; and
a transparent touch area, situated adjacent to the covered area, and most of the transparent touch area being surrounded by the contour line of the electronic device.

2. The touch panel of claim 1, wherein the electronic device is a Smartphone or a flat PC.

3. The touch panel of claim 1, wherein the electronic device includes a flat panel display installed under the transparent touch area.

4. A touch panel, comprising:
a protective substrate, having a covered area and a transparent touch area;
a first sensing electrode layer, having a plurality of first sensing electrodes and a plurality of first lead wires, wherein the first sensing electrodes being installed under the transparent touch area of the protective substrate, and ends of the first lead wires being coupled to the first sensing electrodes respectively, and the first lead wires being installed under the covered area of the protective substrate; and
a second sensing electrode layer, disposed under the first sensing electrode layer, and having a plurality of second sensing electrodes and a plurality of second lead wires, and the second sensing electrodes being installed on a surface of the second sensing electrode layer and under the transparent touch area of the protective substrate, and the second lead wires being installed on the other surface of the second sensing electrode layer, and ends of the second lead wires being coupled to the second sensing electrodes respectively.

5. The touch panel of claim 4, wherein each of the second lead wires is extended along a lateral edge of the second sensing electrode layer and coupled to the corresponding second sensing electrode.

6. The touch panel of claim 4, wherein the second sensing electrode layer has a plurality of through holes, and each of the second sensing electrodes is passed through the through hole and coupled to the corresponding second lead wire.

7. The touch panel of claim 4, wherein the second sensing electrode layer has a plurality of through holes, and each of the second lead wires is passed through the through hole and coupled to the corresponding second sensing electrode.

8. The touch panel of claim 4, wherein the second lead wire is made of a transparent conductive material selected from the collection of graphene, indium tin oxide, indium zinc oxide and zinc aluminum oxide.

9. The touch panel of claim 4, wherein the protective substrate is a transparent thin plate made of a material selected from the collection of glass, polycarbonate (PC), polyethylene terephthalate (PET), polymethyl methacrylate (PMMA) and cyclic olefin copolymer (COC).

10. The touch panel of claim 4, wherein the covered area is made of an opaque material selected from the collection of an ink, a color photoresist, an organic material and an inorganic material.
